(19) United States
(12) Patent Application Publication
(10) Pub. No.: US 2008/0270246 A1
(43) Pub. Date: Oct. 30, 2008

(54) Global electronic payment system

(76) Inventor: Grace Chen, Houston, TX (US)

Correspondence Address: Robert C. Curfiss, 19826 Sundance Drive, Humble, TX, 77346, US

(21) Appl. No.: 11/796,062

(22) Filed: Apr. 26, 2007

(51) Int. Cl. G06Q 20/00; G06Q 40/00

(52) U.S. Cl. 705/17; 705/41

(57) ABSTRACT

A global payment system supports real time payments by a first party to a second party via an electronic interface using any of a plurality of input devices. First party identifying information and information relating to the requested transaction desired by the first party is entered into the system via the selected input device for accessing the payment system. The information is verified and the funds are transferred to a dedicated account for a second party per the instructions received from the first party. The global payment system is a financial transaction system permitting the identified first party to use any of a variety of payment options to complete the transaction without requiring the second party to pre-approve the method of payment. The system is compatible with known ATM/POS debit/credit card formats or other electronic input terminal devices, including either a second party controlled device, or a first party controlled device. This can be but is not limited to a merchant or other service provider controlled device at a retail establishment, or on-line while the user is logged onto a web site from a commercially based computer or from the convenience of his personal computer, or other devices such as a PDA or a cell phone. The information can be swiped by a card reader, or manually entered via a keyboard or other input device such as, by way of example, a cell phone or personal digital assistant (PDA). This flexibility permits a consumer and merchant to complete a transaction in real time anywhere in the world without regard to the consumer's source of funds or the merchant's typical method of payment acceptance.

### BACKGROUND OF THE INVENTION

1. Field of the Invention

The subject invention is related to electronic payment systems and is specifically directed to a system wherein a purchase or financial transaction may be made outside the ATM/POS debit/credit network or the ACH/SWIFT system using electronic terminals, typical point-of-sale terminal systems, PDA, cell phones and the like for supporting point-of-sale transactions and on-line financial transactions from anywhere in the world.

2. Discussion of the Prior Art

Over the last several decades, point-of-sale payment systems have become the normal method of making payment for a transaction. With the current expansion of Internet transactions, the model has been to accommodate the available point-of-sale transaction systems by modifying the system to support use by consumers of computer based terminals, whether commercially or privately controlled.

In point-of-sale transactions, a typical credit or debit card containing cardholder information is read at a point-of-sale terminal which is dedicated to and identifies a specific merchant or other service provider. The merchant or other service provider then enters or captures the transaction data. The information is transmitted, usually via telephone or other communication network system, to the ATM/POS/EFT network where it is transmitted to the cardholder's financial institution. The institution then either approves or rejects the transaction based on the funds or line of credit availability and other preset qualifiers applying to the cardholder at the time of the transaction. If the transaction is accepted, the cardholder's account is immediately debited and typically, the merchant's registered account is credited at a settlement made generally within 1-4 business days. In order for this system to be useful to the merchant and the cardholder, both the merchant and the cardholder have to be registered members of the card issuing network. In addition, the card issued by the financial institution has to be part of the ATM/POS/EFT network.

More recently in North American-centric systems, similar type of transactions are becoming commonplace over the Internet, wherein the purchaser makes a purchase via a computer terminal. In this case, the cardholder typically enters the information carried on the card at the computer terminal while logged onto a merchant or other service provider site. This can be done manually or by using a typical card reader associated with the computer terminal. The remainder of the transaction is the same as with card reader point-of-sale terminals, namely, the merchant provides identifying data and transactional data along with the purchaser's card data. The transaction is then transmitted over the ATM/POS/EFT system to the purchaser's card issuing financial institution where the transaction is either accepted or rejected.

Other types of “cashless” transactions have become available because of the widespread connectivity to the ATM/POS network. For example, some state welfare systems offer debit card benefits. Also, some employers are beginning to issue payroll cards instead of checks. Some card issuing financial institutions issue pre-paid cards which are not tied directly to an account which is to be debited, but include the amount directly on the card or remote controlled data base, to be automatically updated each time a transaction is made.

Typically but not always, debit card transactions require a PIN (Personal Identification Number) to be entered by the customer to complete the transaction. Credit card transactions typically do not require a PIN. This creates a security issue since any person holding the credit card may use it to complete a point-of-sale transaction. The PIN system is not necessarily the answer for security because it requires the user to memorize another number and because PIN supported transactions are not as readily accepted over the Internet. Biometrics and other identification systems are now being introduced to further enhance the security of such transactions.

In all of these types of transactions, in order for a merchant to accept payment, the merchant must be a member of the payment network and the consumer must have a credit or debit card issued or authorized by the same network. In North America this has not presented major problems because almost all financial institutions recognize all ATM/POS transactions regardless of the specific financial institution issuing the consumer card and regardless of the financial institution of a particular merchant.

It is well known that credit cards have been utilized as point-of-sale transaction tools for many decades. In the early years, a paper transaction copy was made and sent to the credit card processor. More recently, electronic point-of-sale terminals have made debit and credit card transactions operate much in the same manner. Specifically, the credit card is electronically read and the user identification and transaction information is sent directly to the credit card issuer where it is either authorized or rejected based on user validity and availability of funds. Both the user/customer and the merchant must be members of the same card payment network system. Specifically, one network system is involved in the transaction. The single payment system accepts the transaction and later settles with the merchant's bank on a prescribed schedule.

Even earlier, and still in use, is the use of checks or drafts as point-of-sale transaction tools. Check readers are now available to authenticate the check but such systems generally do not confirm the availability of funds or electronically reconcile the merchant's account on line at the time of acceptance of the check. In this system the consumer issues a paper check which is received by the merchant and settled via the ACH settlement system. While there have been recent upgrades to the ACH settlement system to make it more desirable as a point-of-sale transaction system, it is still less convenient than either the ATM/POS network or credit card systems. For example, some merchants now have the capability of reading the check electronically and inputting the transaction into the system generally referred to as check truncation, or electronic check conversion. This does not actually immediately debit an account but does permit the POS scanner to read the routing and transmit numbers and the account number contained on the check with the transaction amount manually entered. The information is converted and processed by a check processor and is generally settled within 2-3 business days. Check verification and check guarantee are risked based offerings provided by the third party vendors of the check processor. This system still requires some form of paper check manually completed by the purchaser at the point-of-sale.

When globalization of services enter the picture, the payment transaction systems currently in use become even more complicated. At the present time, Internet transactions are primarily structured around the North American credit card payment model. International consumers cannot readily utilize the system unless they have access to North American issued and supported credit cards. As the on-line commercial trend continues to expand worldwide, this system is quickly becoming archaic since it cannot support on-line commercial activity among many emerging economies. In order to support this emerging opportunity specific on-line payment systems have been established such as e-Bay, PayPal and Neteller. These systems permit consumers to set up an account with the specific provider and then allow the merchant to collect from the provider. In reality, these systems are middlemen, collecting money from a consumer who is not a member of the North American support network and paying to a merchant who may or may not be a member of the North American support network. Each of these systems then internally completes the transaction using legacy systems such as the ATM/POS system or the credit card system without the consumer or the merchant being directly in the loop for that portion of the transaction.

Such systems have been successful both in North America and in other regions of the world and have served as a stop gap answer to the need for an acceptable global payment system. However, even these systems are not functional when the consumer attempts to make payment with a tool not recognized by the system or the merchant is not a member of the particular provider network. Specifically, such stop gap systems fail when each of the components are not part of a system recognized by the provider even though the systems continue to be useful for permitting consumers to deal directly with merchants having incompatible payment acceptance solutions.

Another drawback to each of these systems is that all of theses forms of transaction tools limit each transaction to a single financial account of the consumer user, whether as a cardholder or through the use of a check or draft. In some cases, the consumer may want the transaction to be split among several accounts. By way of example, the consumer may desire to pay a portion of a purchase with a credit account and a portion with a cash or debit account. The present systems can only accommodate this by completing two separate transactions.

In summary, current payment systems rely heavily on the credit card network or the ATM/POS network, both of which are legacy North American transaction systems. This requires that both the merchant and the consumer are members or account holders of compatible financial institutional systems. The system permits only one purchaser account to be accessed during each transaction. The system users incur managed transaction fees for every transaction.

Therefore, there remains a need for a globally accepted payment transaction system that is not tied to the costly legacy ATM/POS network, credit card system network or ACH settlement system. There is also a need to permit consumers with the flexibility to settle transactions utilizing a plurality of accounts without requiring separate transactions tied to each specific account.

### SUMMARY OF THE INVENTION

The subject invention is directed to a new and novel payment system that does not rely only on credit or debit cards infrastructure, does not require the merchant and purchaser to have compatible memberships to complete a transaction, and does not limit single transactions to a single account. The system has a wide range of flexibility and permits debit, credit, stored-value (payroll card, expense card, gift card and the like) cards and other virtual accounts to be accommodated in a seamless and invisible manner. The transaction may be verified and approved at the point-of-sale whether or not the merchant is a member of a specific financial transaction system. Certain aspects of this system are disclosed and described in my earlier U.S. patent application Ser. No. 10/622,718, entitled: CASHLESS PAYMENT SYSTEM, filed on Jul. 18, 2003 and incorporated by reference herein.

The subject invention is in essence a digital wallet whereby a consumer anywhere in the world can complete a transaction with a merchant without having a payment transaction system that is necessarily compatible with the merchant's point-of-sale network. Settlement with the merchant is completed by the system without regard to source of funds from the consumer. A simple explanation is that the consumer accesses his digital wallet in accordance with pre-selected criteria and places finds in the hands of the global system. The merchant then accepts a transaction from the consumer and collects from the global system at settlement. The merchant does not need to know the identity or location of the consumer and does not need to know the source of the funds. The consumer does not need to know or have access to the transaction tools accepted by the merchant. The payment system of the present invention not only supports all legacy systems such as credit card systems, ATM/POS systems and ACH/SWIFT settlement systems, it also supports both consumers and merchants who do not have access to these tools. This is particularly important in emerging economies such as, by way of example, India and China, both of which have extensive banking networks that are not compatible with the North American centric legacy systems. As the consumer economy becomes more global in nature, the ability to accommodate both consumers and merchants who are not part of the legacy systems networks becomes not only desirable but essential.

The global payment system of the subject invention supports real time payments by a first party to a second party via an electronic interface using any of a plurality of input devices for receiving first party identifying information and information relating to the requested transaction desired by the first party. This information is transmitted to the payment system for accessing the first party's account or digital wallet. The information is verified and the funds are transferred to a dedicated account for the second party per the instructions received from the first party.

Specifically, the financial transaction system of the subject invention is a payment transaction system that permits an identified customer to use any of a variety of payment options to complete the transaction without requiring the merchant to pre-approve the type of payment selected by the customer. When a transaction is to be completed, the consumer enters the identifying information associated with his account. This can be in a credit card format or using a terminal wherein the information is entered, including a merchant terminal, or a consumer controlled devices. Specifically, this can be a merchant or other service provider controlled device at a retail establishment, or on-line via wired or wireless connection while the user is logged onto a web site from a commercially based computer or from the convenience of his personal device such as a computer, or other location. The information can be swiped by a card reader, or manually entered via a keyboard or other input device such as, by way of example, a cell phone or personal digital assistant (PDA). This flexibility permits a consumer and merchant to complete a transaction in real time anywhere in the world without regard to the consumer's source of funds or the merchant's typical method of payment acceptance.

In the preferred embodiment of the invention, the system assures the integrity of the consumer and thus protects the merchant from fraudulent transactions, reducing the likelihood of fraud and decreasing substantially the probability of bad debts to be absorbed by the merchant.

The system of the present invention can integrate with international banks, regional banks and national banks to move funds electronically between consumers and merchants, between merchants and merchants and between consumers and consumers. This system operates electronically to support on-line and point-of-sale payment services that permit the use of all legacy electronic systems such as ATM/POS cards and credit cards by utilizing and extending the existing international banking structure, permitting a secure means for transferring funds throughout the world. This provides merchants with a secured and seamless payment process regardless of the type of business or the physical geographic location. The payment system supports both bank customers and those customers who do not deal with banks, typically referred to in the industry as an unbank customer. The unbank customer will not have a bank account but will deal primarily in cash. The subject invention allows the unbank customer to load his digital wallet at any member merchant with cash, a payroll check, or other forms of currency or tender, and then make transactions at any point on the system by moving funds from his digital wallet, once loaded.

The digital wallet is compatible with and may be combined with branded prepaid cards for both the consumer and the merchant. This enables the account holder to deposit, withdraw and transfer funds to and from any number of existing accounts.

In one implementation of the system, the consumer may even cash load his account at merchant locations via a wireless interface such as his personal PDA or cell phone.

The integrated electronic money movement and automated customer services is the core technology of the invention. This provides a payment engine for supporting entertainment, commerce and financial services under any existing platform using both fixed or wired and mobile or wireless systems. It is also very useful for business-to-business procurement and other business process outsourcing (BPO's). The digital wallet provides a useful tool for health care payments, wherein the patient merely uses his digital wallet to pay and the co-pay and deductible are automatically deducted from his prioritized accounts with the bulk of the payment being deducted from his carrier. This is particularly useful when using health care savings accounts.

The technical base of the system can be readily expanded to support payment systems for IT services as well as BPO's, adding a new dimension to these services by providing invoicing and collection for services anywhere in the world without relying on the legacy bank-controlled money transfer systems. Specifically the technical core of the payment system of the subject invention supports corporate procurement services as well as accounting for any type of service, including but not limited to health care, utilities and other services. By way of example, in health care an insured patient may pay for services with his digital wallet and the system will automatically deduct the co-pay from the patient's account and the remainder from the covering insurance program.

In order to support widespread acceptance and use, the consumer's digital wallet may be in the form of a stored value processing (SVP) platform in a credit card or debit card format. This would permit the consumer's information to be transmitted via an ATM/POS gateway in standard fashion, along with the transaction data and the merchant related information, including but not limited to merchant identification, merchant location, nature of business and the merchant's standard industrial code (SICO). A virtual switch would then intercept the transmitted transaction information and redirect it from the ATM/POS system to the system of the subject invention.

While one embodiment of the invention utilizes an ATM/POS network and diverts the transaction once initiated, the system is designed to be and can function as a fully self-contained money management and settlement system. The ATM/POS gateway is used as a convenience because of its widespread acceptance and availability. The system can be configured to direct all transactions directly to a system gateway where desired without any loss of transaction processing flexibility. It should be understood that the invention is not so limited.

For example, it is anticipated that in many regions of the world a cell phone will be the platform of choice. In this case, the consumer information is simply entered into the consumer's cell phone, along with the merchant information and the merchant will receive at his location near real-time approval from the system. In lay terms, the consumer simply makes a financial transaction using his digital wallet and credits are applied to the merchant's account by entering the proper transaction information into a device communicating with the system, which may be a computer, a PDA, a cell phone, a point of sale terminal or other similar device. Because of the flexibility of the system and the low costs of each transaction, micropayments are supported as efficiently as large, typical credit card transactions.

The consumer is a member of the system and will have instructed the system to handle his transactions in a specific manner. For example, the consumer member may instruct the system to prioritize use of his accounts, e.g., first debiting a cash account so long as the balance stays above a specific floor, and then charging the transaction to one or more credit accounts. The credit accounts may be standard branded systems or may be unique to the system. In addition, the system will permit customization not previously supported. For example, if a service provider is a medical clinic and the consumer has a health plan with a co-pay or deductible, the system will permit the customer to pay for the services and automatically deduct the co-pay or deductible from a customer cash or credit account while making the remaining payment from the insurance carrier account.

In another example, a third party account may be issued by the consumer member, such as, by way of example, a student card. In this application, the holder of the student card will be authorized to make certain transactions within preset time and amount limits, or other criteria. However, the transaction may be directed to the consumer member's selected accounts rather than requiring a pre-paid account to be set up for the student. Any number of linked accounts may be set up this way by a member.

The system of the subject invention supports a wide range of flexibility, permitting issuing systems such as companies, government agencies and even parents or guardians to restrict the types of authorized uses while permitting users to access accounts in a prioritized manner.

The accepting merchant is not required to be a member because settlement with the merchant may be made via the ACH system by typical and standard electronic transfer. This permits the merchant to take advantage of the lower ACH transaction fees with even greater convenience and flexibility than the current ATM/POS card payment system even though the consumer may be using an ATM/POS card or a credit card. The system is even more flexible as the concept of the digital wallet supports transactions without any form of payment tool being utilized at the point-of-sale.

The system of the subject invention supports numerous types of identification methods from typical credit card structures with magnetic data strips to various biometric systems such as finger prints, facial recognition and the like. Specifically, once the consumer is identified, the transaction is managed by his authenticated membership data on record with the transaction processing system.

### BRIEF DESCRIPTION OF THE DRAWINGS

FIG. 1 is an overview of the interrelationship between the various components of a transactional activity in accordance with the subject invention.

FIG. 2 is a simple flowchart illustrating the flow of a transaction from a remittance sender to a remittance receiver.

FIG. 3 is an overview of the payment system infrastructure.

FIG. 4 is a flow chart showing the architecture of the system illustrated in FIG. 3.

FIG. 5 shows the network structure for supporting the system illustrated in FIG. 3.

FIG. 6 is a flow diagram of a typical transaction made using the payment system of the subject invention.

FIG. 7 is a diagram showing the business merchant/agent payment infrastructure.

FIG. 8 illustrates a basic point-of-sale transaction utilizing the payment system of the subject invention.

FIG. 9 is a diagram demonstrating a typical settlement process in accordance with the subject invention.

FIGS. 10, 11 and 12 are diagrams illustrating in detail the transaction processing function of the subject invention.

FIG. 13 is a comprehensive system overview for support the global payment system, IT service engine and BPO capabilities of the subject invention.

### DETAILED DESCRIPTION

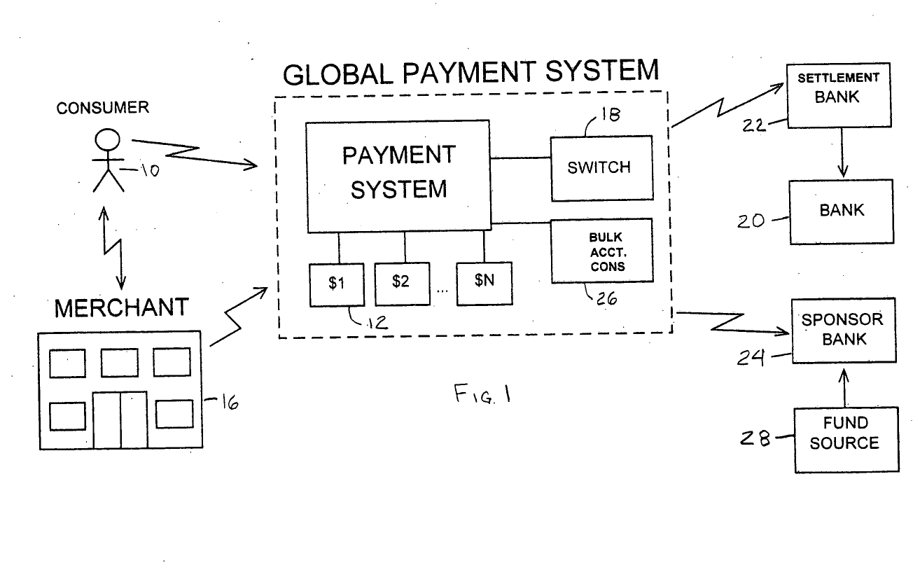

An overview of the global payment system of the subject invention is shown in FIG. 1. The system does not rely on credit or debit cards, does not require the merchant and purchaser to have compatible memberships to complete a transaction, and does not limit single transactions to a single account. The system has a wide range of flexibility and permits debit, credit, stored-value (payroll card, expense card, gift card and the like) cards and other accounts to be accommodated in a seamless and invisible manner. The transaction may be verified and approved at the point-of-sale whether or not the merchant is a member of a specific financial transaction system. Certain aspects of this system are disclosed and described in my earlier U.S. patent application Ser. No. 10/622,718, entitled: CASHLESS PAYMENT SYSTEM, filed on Jul. 18, 2003 and incorporated by reference herein.

The system creates a digital wallet whereby a consumer anywhere in the world can complete a transaction with a merchant without having a payment transaction system that is necessarily compatible with the merchant's point-of-sale network. Settlement with the merchant is completed by the system without regard to source of funds from the consumer.

As shown in FIG. 1, simple explanation is that the consumer 10 accesses his digital wallet 12 in accordance with pre-selected criteria and places finds in the hands of the global system payment system 14. The merchant 16 then accepts a transaction from the consumer and collects from the global system 14 at settlement. The merchant does not need to know the identity or location of the consumer and does not need to know the source of the funds. The consumer does not need to know or have access to the transaction tools accepted by the merchant.

The payment system of the present invention not only supports all legacy systems such as credit card systems, ATM/POS systems and ACH settlement systems, it also supports both consumers and merchants who do not have access to these tools. This is particularly important in emerging economies such as, by way of example, India and China, both of which have extensive banking networks that are not compatible with the North American centric legacy systems. They don't have the same access and business discipline regarding the credit card system. As the consumer economy becomes more global in nature, the ability to accommodate both consumers and merchants who are not part of the legacy systems networks becomes not only desirable but essential.

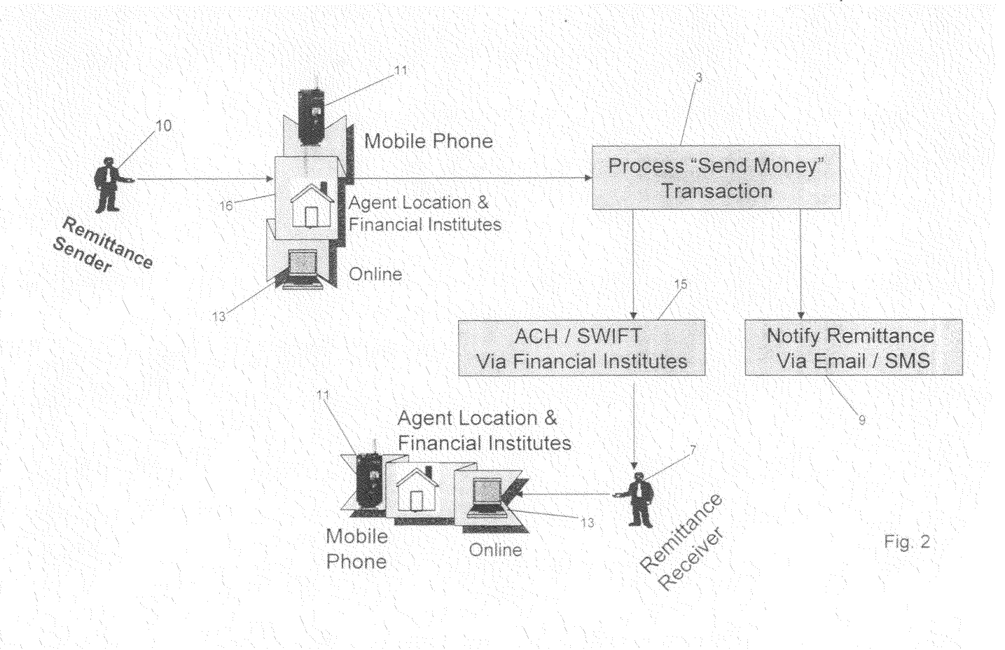

FIG. 2, shows a typical example of a transaction using the system of the present invention. A first party, or sender 10 accesses the system via an electronic device such as a cell or mobile phone or other PDA 11, his personal computer 13, or a terminal provided at an agent or merchant location or member financial institution 16. The consumer 10 then initiates a “send” order as indicated at 3. The system then takes this request and performs appropriate functions as more completely described with reference to FIG. 2. The transaction is then approved and transmitted via appropriate financial institutions using appropriate switching such as the ACH or SWIFT as indicated at 15. This transfers funds to the second party or remittance receiver 7 at the appropriate location which again may be via cell phone or the like 11, a computer device 13 or at a specified agent or financial institution 13. Remittance notification is sent via e-mail/sms or other electronic means, as indicated at 9.

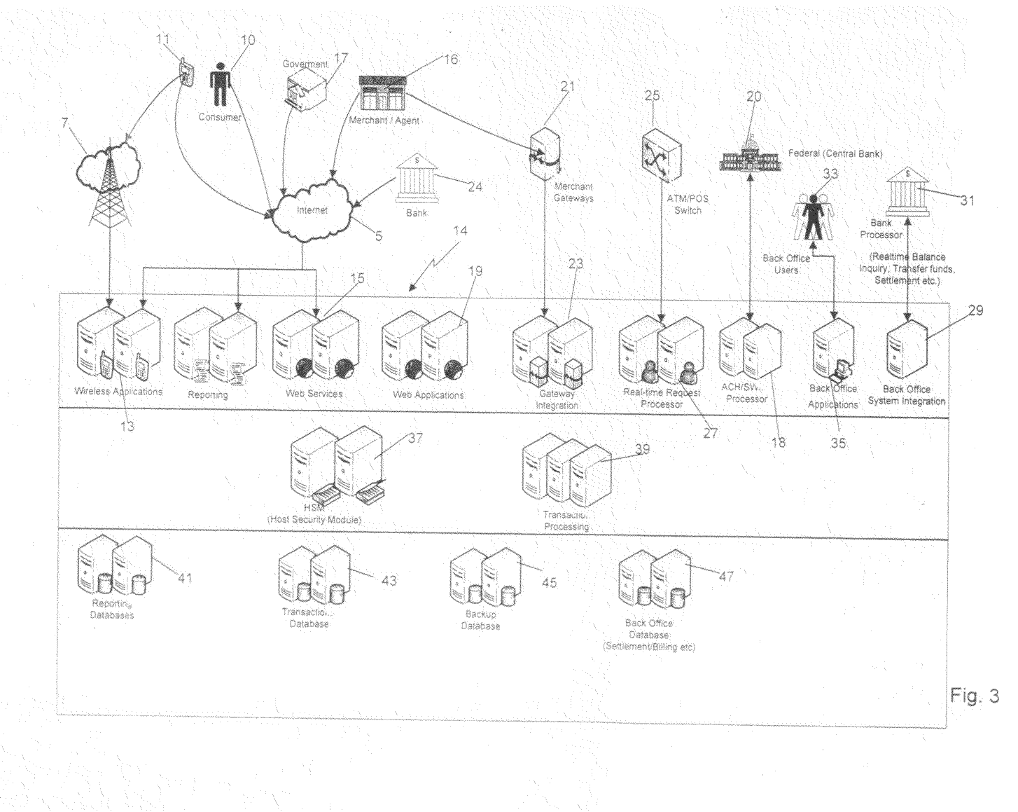

The system infrastructure is illustrated in FIG. 3. As shown, the system permits multi-level payments utilizing a hierarchy group level relationship and a consolidation account architecture. Specifically, the financial transaction system 14 of the subject invention is a payment transaction system that permits an identified customer or consumer 10 to use any of a variety of payment options to complete the transaction without requiring the merchant or agent 16 to pre-approve the type of payment selected by the customer. When a transaction is to be completed, the consumer 10 transmits the identifying information associated with his account to the global payment system 14. This can be in a credit card format or using a terminal wherein the information is captured, including a merchant device such as a point-of-sale terminal or a computer station, or a consumer controlled device such as a personal computer or a cell phone or PDA or other electronic input device as indicated at 11. The consumer/user can communicate with the system 14 via the Internet 5 or other wireless network 7. The same is true for other outside participants such as the funding sources shown, by way of example, as a government agency 17, a merchant agent 16 and a finding bank 24. The information can be swiped by a card reader or other automated reader device, or manually entered via a keyboard or other input device. This flexibility permits a consumer and merchant to complete a transaction in real time anywhere in the world without regard to the consumer's source of funds or the merchant's typical method of payment acceptance.

the system infrastructure includes a number of applications, reporting functions and services for completing a transaction. Wireless applications 13 support the use of and receipt of data from sources not connected to the internet. Web services 15 and web applications 19 likewise support Internet communications. This permits the system to receive information from and provide information to the various components of a payment transaction including the consumer 10, the merchant/agent 16, and various funding sources such as a government agency 17, a funding bank 24, another consumer 10 or a merchant/agent 16.

The merchant/agent is also connected to the system through a merchant gateway 21. The system 14 supports merchant gateway integration as indicated at 23. This is where the merchant information is maintained, including but not limited to: merchant identification, merchant location, nature of business and the merchant's standard industrial code (SICO).

As shown at 25, the system 14 also supports communication via the legacy ATM/POS terminals as indicated by the ATM/POS switch 25 and the real-time request processor 27. Legacy ACH/SWIFT processing is also supported as indicated by the central bank 20 and the ACH/SWIFT Processor 18. The back office system integration 29 provides communication with a bank processor 31 for balance inquiry, funds transfer, settlement and other typical legacy banking functions. For clarity, the system personnel 33 are illustrated and communicate with the system via back office applications as indicated at 35.

The next layer of functionality are the HSMs or host security modules 37 and transaction processing modules 39. The host security modules provide fraud protection and transaction security. The transaction processing modules complete the requested transaction and communicate the transaction to the various involved transaction components (for example the consumer, merchant and funding bank) once the security and fraud checks are complete.

All of this is supported by the various databases as indicated at reporting database 41, transactional database 43, backup database 45 and back office database 47.

A simplified explanation of how this works follows. Once the consumer transmits information requesting a specific transaction to the system 14, the system 14 communicates acceptance to the merchant 16 and the transaction is completed. The payment system 14 then debits or credits the consumer account 12 for the amount of the transaction. The system also credits or debits the merchant account 18. The payment system handles each individual transaction independently for each consumer and each merchant and directly debits or credits their individual accounts depending on the type of transaction. Before completing the transaction, the system authenticates the consumer and the merchant/agent and the source and availability of funds. This is all accomplished internally within the system.

It should be noted that any type of cash transaction can be handled in this manner. For example, a typical transaction is the consumer purchasing goods or services from a merchant. In this case, the consumer account is debited and the merchant account is credited. However, refunds can also be handled in this manner. Also, the merchant could receive cash from the consumer and upload, i.e., increase the balance in the consumer account, in which case the merchant would receive cash but his account would be debited in that amount and the consumer account would be credited. The merchant system account is debited because the merchant has an equivalent amount of cash in hand from the consumer. In another example, the consumer may seek a refund for returned goods or the refund of a deposit for services, and in such a case the consumer account would be credited and the merchant account would be debited.

All of the above transactions, and any other transactions between parties are handled internally within the payment system 14, without the involvement of any bank or other financial institution. At settlement, the payment system 14 communicates with various banks and other financial institutions through a plurality of switches as indicated at 18 (see FIG. 1). By way of example, in the United States the settlement vehicle of choice may be the ACH system. Switch 18 is then an ACH system switch through which funds are transferred via a central bank, in this case the U.S. Federal Reserve 20 (also FIG. 1) using the ACH settlement tools 22.

The finds do not have to be tied to individual consumers or merchants at settlement but may be handled in bulk, combining the sum of all accounts for a bank 24 at bulk consolidation 26. Again, by way of example, if a plurality of merchants and a plurality of consumers have their primary account at bank 24, then the system only has to report to bank 24 the change in account status at settlement, not each individual transaction. The individual transactions are maintained entirely within the payment system 14.

The original source of funds 28 using the system of the invention may be banks, their customers, merchants, third party individuals, consumer's employer, a government agency, the consumer directly, government agencies or any other party authorized to load the digital wallet of the user. The system can accommodate any type of cash transaction. Specifically, the consumer can initiate payment to a merchant for the receipt of goods or services. The consumer can deliver cash to a merchant who then acts as an agent to accept funds on behalf of the system for loading the consumer's digital wallet, whereby the consumer can then complete other transactions. Government and private agencies, banks and even other individuals can load, transfer and receive funds via the system. This can all be accomplished without using any of the legacy money transfer tools such as ATM/POS debit/credit cards or EFT (electronic funds transfer) such as the ACH or SWIFT networks. This permits such transactions to be completed under a lower cost structure with improved convenience and with a shorter lead time, thereby reducing float, all of which reduce the speed and cost of each transaction.

Access to the system is initiated by the consumer providing a profile including sources of funding. The tools supported include an SVP (stored value platform) card, a debit card, a digital wallet, or an electronic transmission tool. The electronic transmission tool may support cell phone transactions other wireless transactions such as PDA's or on-line transactions via computer.

At the time the consumer provides his profile he will have the opportunity to prioritize the manner in which his account is loaded. For example, he may direct the account first be loaded by withdrawing funds from his checking account at a bank. Once these are exhausted, or a floor balance is reached, he may direct the system to shift to a savings account and then to a credit card account he has previously opened. At the time a transaction with a merchant is completed, the movement of funds from each of these accounts is seamless and is not transmitted to the merchant. As an example, if the consumer buys a big ticket item he may not have enough funds in his checking account to cover the transaction. Once the checking account funds are exhausted the remainder of the purchase might be put on his credit card account. This is all handled internally by the system and is not relayed to the merchant. The merchant simply gets an indication that the full amount has been approved and will be transferred into the merchant's account.

A significant advantage to this system is the ability of the consumer to use a variety of sources of funds whether or not the merchant normally accepts them. This is particularly useful for transactions involving systems that are not North American-centric. Specifically, the system is global in nature. Sources of and transfer of funds may be accomplished regardless of the input devices used and the settlement systems employed. An additional advantage is that anonymity of the consumer's source of funds is preserved and shielded from the merchant. Also, because of the bulk transfer settlement, the anonymity of the consumer and his use of funds are shielded from the bank.

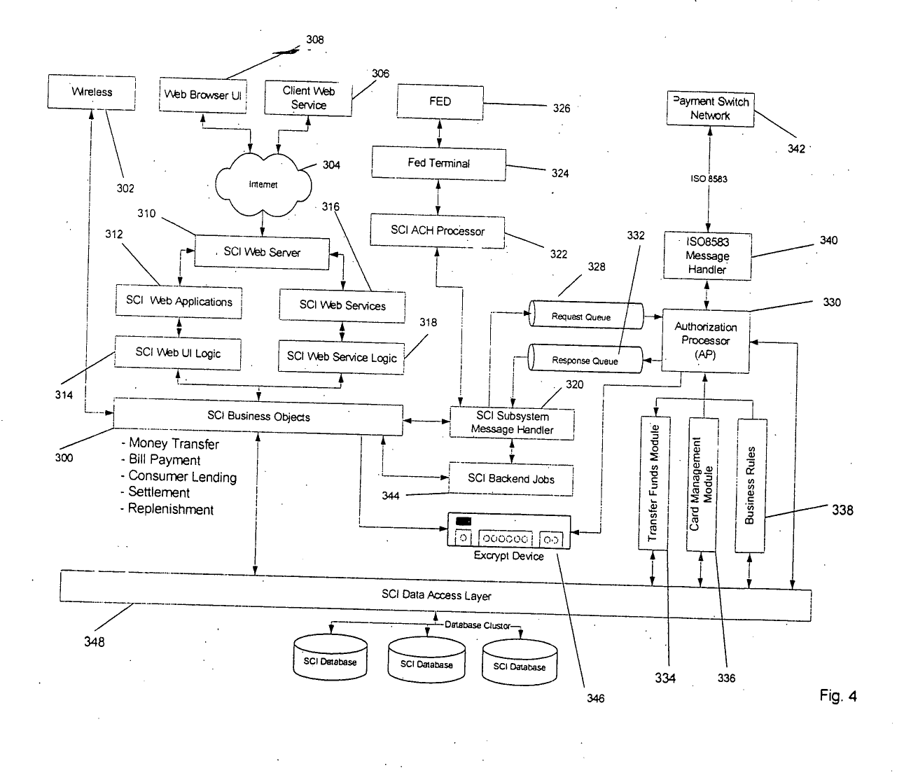

The system architecture is shown in FIG. 4. The system business objects 300 are connected to external systems via wireless communications 302 or via the internet 304 to a client web service 306 or a web browser interface 308. The business objects block is symbolic of the types of transactions the system will handle, e.g., money transfers, bill payments, consumer lending, settlement and replenishment. When connecting via the web, the system web server 310 is in communication with the Internet and communicates with the system business objects via web applications 312 and web logic 314 and/or web services 316 and web service logic 318. The subsystem message handler 320 communicates with the ACH/SWIFT processor 322 to direct transmissions to and from a central bank terminal 324 and a central bank 326.

A transaction request is transmitted to the system business objects 300 via wireless interconnect 302 or the Internet 304. This is communicated to the message handler 320 and entered into the request queue 328 for processing at the authorization processor 330. A response is queued and sent back through the subsystem message handler as indicated at 332. Authorized requests initiate the transaction and activate the transfer funds module 334, card management module 336 and the business rules 338 associated with the consumer and specific transaction. The authorization processor 330 then transmits the transaction to the message handler 340 for transmission to the payment switch network 342.

Backend jobs are shown at 344. Also, where desired, encrypt devices 346 may be employed. The data access layer 348 provides between the system data base in the data base cluster 350 and the rest of the system.

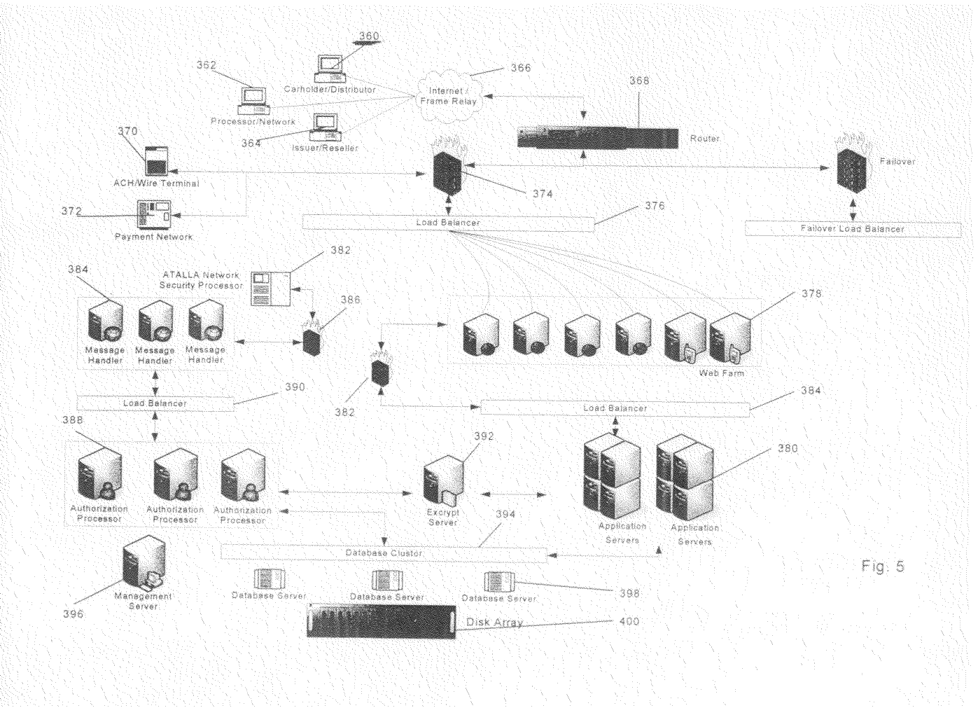

A typical layout of the network architecture of a system in accordance with the subject invention is illustrated in FIG. 5. The external components are the cardholder/distributor terminals or devices 360, external processors 362 and a merchant/agent processor or terminal at the issuer or reseller location as indicated at 364. Each of these devices communicates with the system via the Internet or an equivalent frame relay system 366 to a router 368. ACH/wire terminals 370 and payment networks 372 are also external of the system. The system is firewall from external system contamination as indicated at 374.

External communication with the system in managed by a load balancer 376, which directs transmissions to the web farm 378. The web farm then handles traffic to and from the application servers 380. This traffic is also fire wall protected as indicated at 382 and a load balancer 384.

Point of sale transactions (POS) and automatic teller machine transactions (ATM) are transmitted to a network security processor 382 for communication with the message handler system 384. This traffic is firewall protected as indicated at 386. The message handler system 384 is in communication with the authorization processor module 388 via load balancer 390. An excrypt server 392 may be employed.

The application servers 380 and the authorization processors 388 access the database cluster 394 as indicated. The database cluster typically includes a management server 396, various database servers 398 and storage array(s) 400.

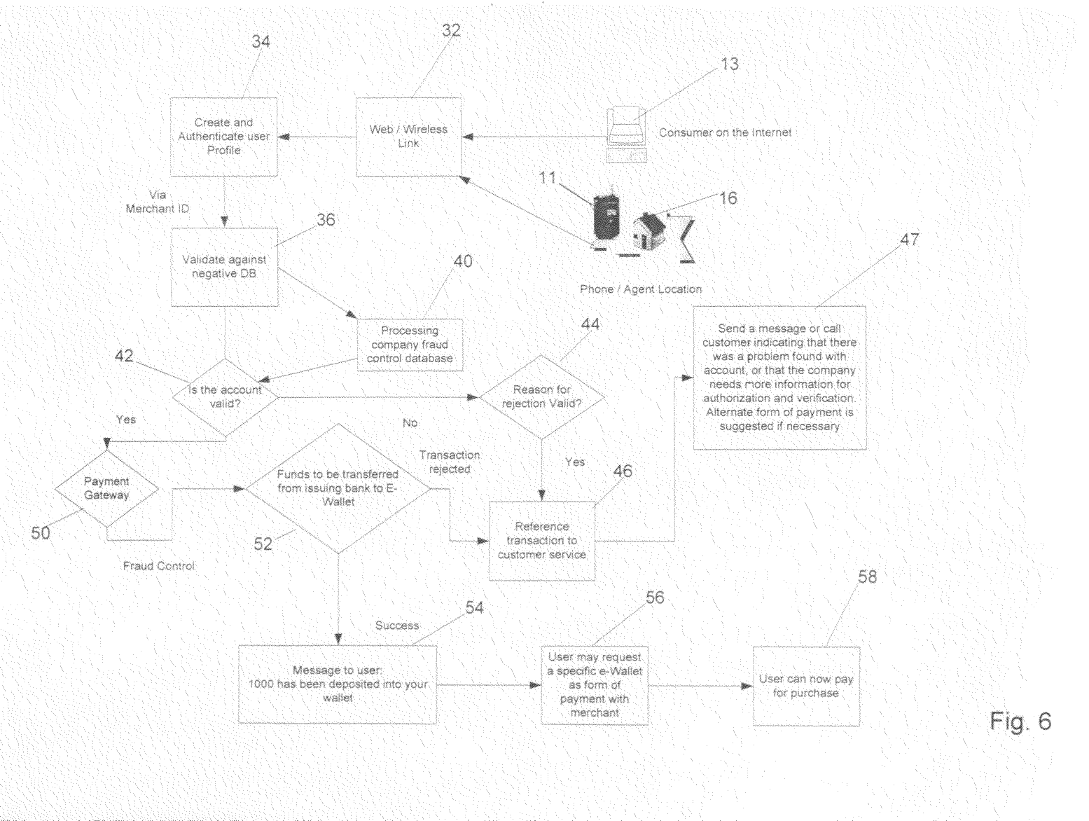

A typical flow diagram following a transaction is shown if FIG. 6. This diagram assumes the consumer is at a computer terminal 13 but it should be understood any of the previously mentioned input devices may be used, including but not limited to a point-of-sale terminal 16, a cell phone or a PDA 11 as also indicated. The transaction is initiated by going on-line as indicated at 32 or otherwise activating the system using one of the other input devices. The consumer identification is then entered at 34 to first create and later authenticate the user profile. The system then confirms that the account is valid by entering the information into a clearing house negative data base 36 and a fraud control data base 40. The account is then passed or rejected at 42. If the account is rejected it is rechecked at 44 to assure that the rejection is correct and the rejection is referred to customer service at 46. At this point, the consumer is contacted by any of a variety of means such as e-mail, telephone or other device to determine what additional steps need to be taken to place the account in satisfactory condition, as indicated at 47.

a valid account which has been approved at step 42 is introduced into the payment gateway 50. At this point the digital wallet is loaded from the issuing bank as indicated at 52. In the event the issuing bank rejects the transaction, the transaction is again referred to customer service as indicated at 46. If the transaction is accepted, the digital wallet is loaded and confirmation is forwarded to the consumer as indicated at step 54. The consumer may utilize any of the variety of payment forms previously disclosed, including an SVP card, a debit or credit type card, or direct electronic transfer, as indicated at step 56 and complete the transaction with the merchant as indicated at step 58.

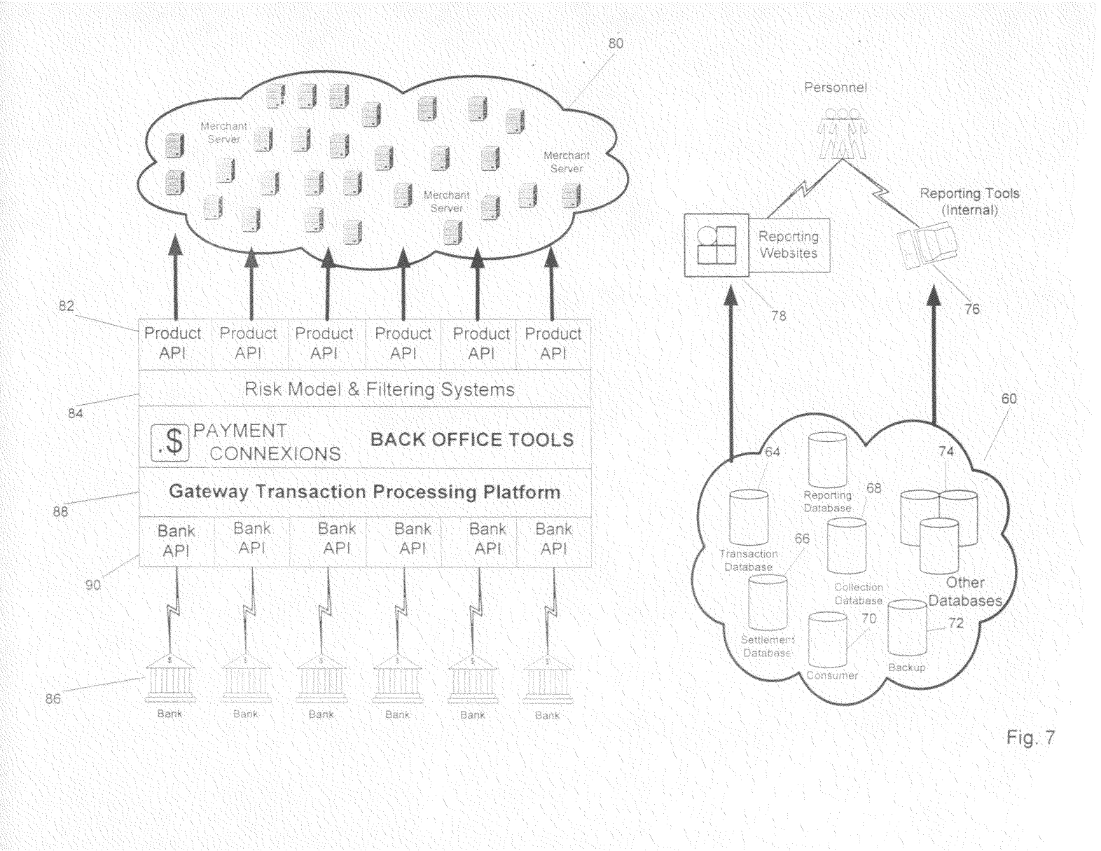

FIG. 7 is a diagram showing the merchant approval and payment processing system support for the payment system of the subject invention. This all occurs within the control of the payment system and outside the public banking networks. As shown in FIG. 7, the system servers 60 may be located anywhere on the Internet and may be centrally located or strategically place in a plurality of locations. This includes but is not necessarily limited to the reporting data base server 62, the transaction data base server 64, the settlement data base server 66, the collection data base server 68, the consumer data base 70, appropriate back servers 72 and other data base servers 74 as needed. These all fit within the infrastructure previously described in connection with FIG. 3.

The internal reporting tools 76 may also be connected via a local area network (LAN), secure wide area network (WAN) or the Internet. This system is in communication with the reporting websites 78 for communication with the plurality of member merchant servers as indicated by cloud 80. The payment connections and various back office tools are then available via the various product application program interfaces (API's) 81 to the merchants, as indicated at 82, including appropriate risk modeling 84. Finally, communication with the banks 86 is via the gateway transaction platform 88 and the bank API's 90 to complete the payment transaction processing function.

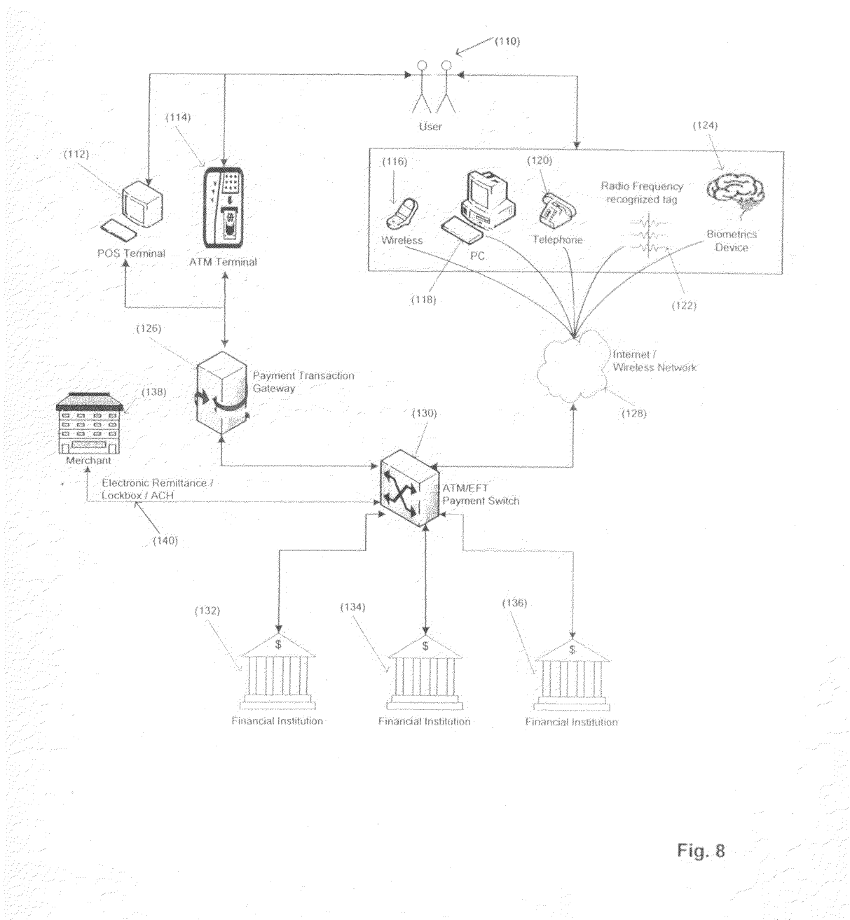

The payment gateway is illustrated in FIG. 8. The system of the subject invention permits users/consumers 110 to set up an account with a loaded balance for completing financial transactions in a wide variety of applications. The consumer 110 is assigned valid credentials which permit him to log onto the system via a variety of input devices such as the point-of-sale (POS) terminal 112, the ATM/POS terminal 114, a cell phone or other wireless device 116, a personal computer 118, telephone 120 or other input device. The system also supports input devices such as radio frequency or infrared tags or similar devices 122 and biometric identification such as finger prints, facial recognition or other system 124.

The input devices permit the consumer 110 to log on in a variety of ways. For example, a radio frequency tag 122 may be mounted on the windshield of a vehicle for payment of tolls on a toll road. The POS and ATM terminals 112 and 114, respectively, may be used for typical credit/debit card type transactions. Biometric identification systems 124 may be useful for many transactions where security is of significant concern.

The purpose of each of the input devices is to provide validating data identifying the user. In the case of the POS terminal and the ATM terminal, the user data is transmitted to a payment transaction gateway 126 where it is diverted from the ATM/POS system to a virtual switch 130. In the case of other input devices, the data will be transmitted via other network systems such as the Internet as indicated by the cloud 128, hard wired telephone lines, wireless communication systems or the like. This transaction data is transmitted in a similar fashion to the virtual switch 130.

At this point, the virtual switch will contain the user identification, the transaction detail and the merchant profile as previously described. The virtual switch 130 then accesses the user's financial institution(s) 132, 134, 136 or funds sources to determine the availability of funds in the priority established by the user when he set up the account. The system then communicates to the user and the merchant whether the transaction is accepted or declined. If accepted, the system will then settle with the merchant at a prescribed interval by making an electronic transfer from the selected funds source or financial institution(s) to the merchant 138 via the EFT network which includes but is not limited to ACH, SWIFT, wire transfer and lockbox systems as indicated at network 140.

The virtual switch system 130 is more fully described in my aforementioned co-pending application Ser. No. 10/622,718, incorporated herein by reference. In summary, a transfer request is made by the user at one of the input devices. The virtual payment switch receives the request and then communicates with the selected financial institutions or other EFT Network connections as proscribed by the routing rules configured in the virtual switch to determine whether the request may be authorized. This decision is then communicated back to the input device and/or merchant. Upon settlement, the funds are electronically transferred via the virtual switch.

This system provides an authorized accounting process on money movement requests with assured proper financial transactional logistics. Web based money movement is supported through authorized processing to direct, validate and fulfill financial transaction requests from any of the wide variety of available input devices. The settlement instruction sets among all participants is based on logic that is defined and verified by the participants, permitting credit, debit and cash transactions as directed. Full audit trails are generated and maintained.

The settlement process is shown in more detail in FIG. 7. As previously stated, the user 110 will select one of the input devices or terminals 112, 114, 116, 118, 120, 122, 124, 125 in order to make a transaction request. The user identification and the request is contained in a user file 111a which is transmitted to an EFT (electronic funds transfer) network 129. The merchant acquirer 138 provides identifying and transaction information in a merchant file 111b which is also transmitted, as appropriate to the EFT. The combined files 111a and 111b are then transmitted to the payment agent 130 for processing by the system 150. The system initiates an authorization process 152 and a settlement process 154 using the customer data base 156. The issuer bank(s) 158 and 160 then transmit the funds via the appropriate electronic transfer system 162 depending on criteria provided by the issuer bank. The funds are then credited to the merchant bank(s) 166, 168. Other sources of funds may be the North American-centric VISA, MasterCard or Pulse bank system processors as indicated at 164.

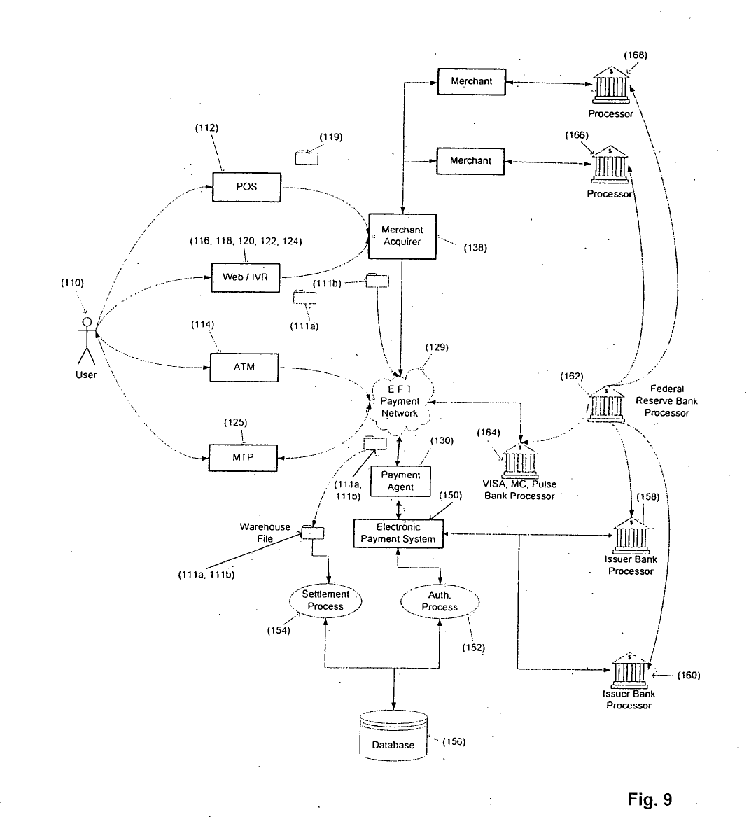

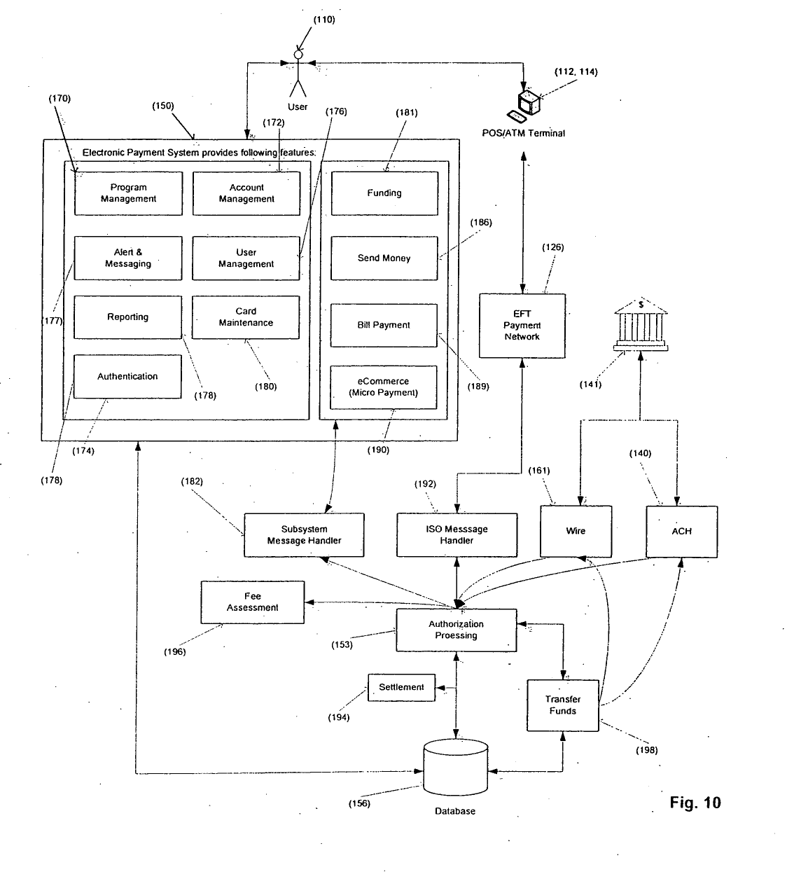

FIGS. 8, 9 and 10 illustrate transaction processing and comprise the core payment engine of the system. These charts illustrate the flow of information for supporting the transaction process, including fraud management and show the steps required to authorize a transaction and process completion to support a purchaser, merchant and various processing switches. This permits completion of settlement with appropriate notification. Specifically, FIG. 10 is a diagram illustrating some of the available features of the system. This shows the enhanced features of the system, particularly when compared to the ATM/POS network payment system. As indicated at the system level 150, the system provides program management 170 and account management 172 in addition to authentication 174. When the user becomes registered, he supplies account management information which is used through the user management feature 176. This is entered in the database 156 and utilized for authenticating the user and managing his accounts during each transaction. This program management provides a flexible payment system for the user while at the same time minimizing any merchant membership requirements. In addition, the system provides alert and messaging capabilities 177, reporting 178 and card maintenance 180.

The system is also adapted for communicating with a subsystem message handler 182 for supporting funding 181, generating “send money” transactions 186, supporting bill payment 188 and for use as an eCommerce payment system 190. During the authorization processing sequence indicated at 153, the subsystem message handler 182 communicates with the system and an ISO message handler 192 communicates with the payment network 126. The settlement 194, fee assessment 196 and transfer of funds 198 are all managed by the authorization processing system 153 for communicating with the source of funds 141 and actuating transfers of funds via wire transfer 161 or via the ACH/SWITCH system 140 or other financial transfer systems. The completed transaction is then reported back to the initiating device 112, 114.

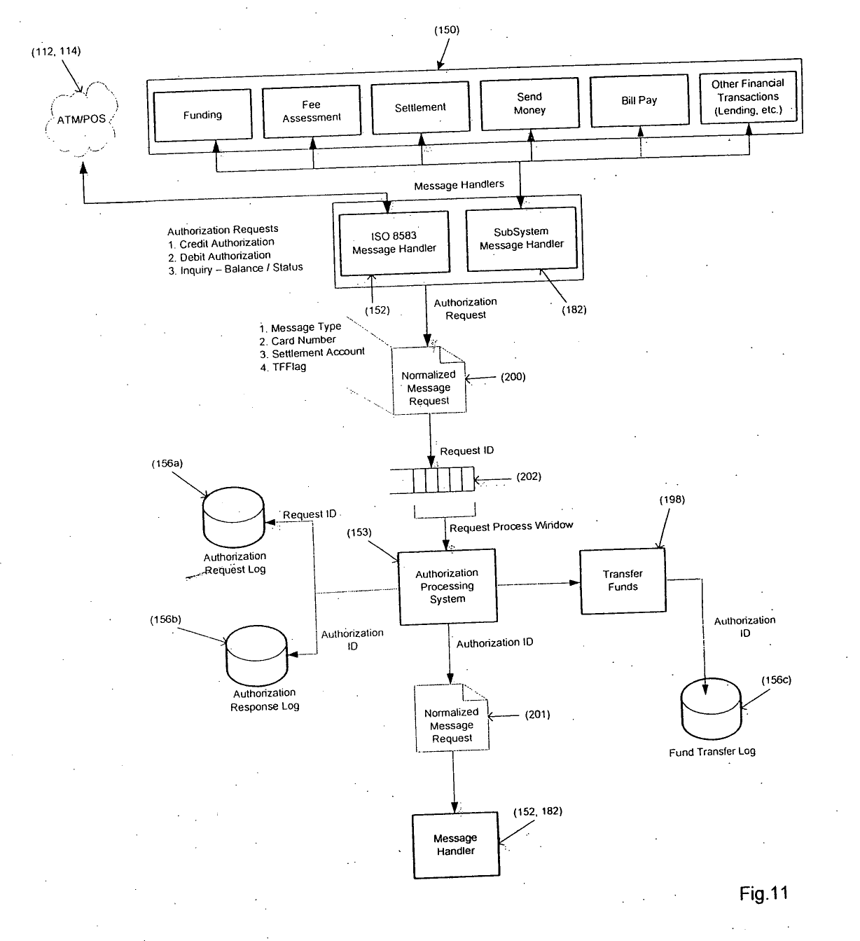

The transaction engine is shown in FIG. 11. The user data entered at the ATM/POS terminal 112, 114 or other input device, as previously described, is transmitted to the message handler 152 for generating an authorization request 200. The request is issued with a request specific ID 202 and transmitted to the authorization processing system 153. This is transmitted to and logged in the database as a request ID 156a and an authorization ID 156b. The accept or rejection response is generated as a normalized message at 201 and transmitted back to the message handler system 152, 182. The authorization processing system transmits funds transfer information to the transfer funds system 198 and this is logged in the data base with the authorization ID at 156c. The authorization information is transferred to the system 150 for managing funding, fee assessment, settlement and the transaction such as send money or bill pay, as previously described.

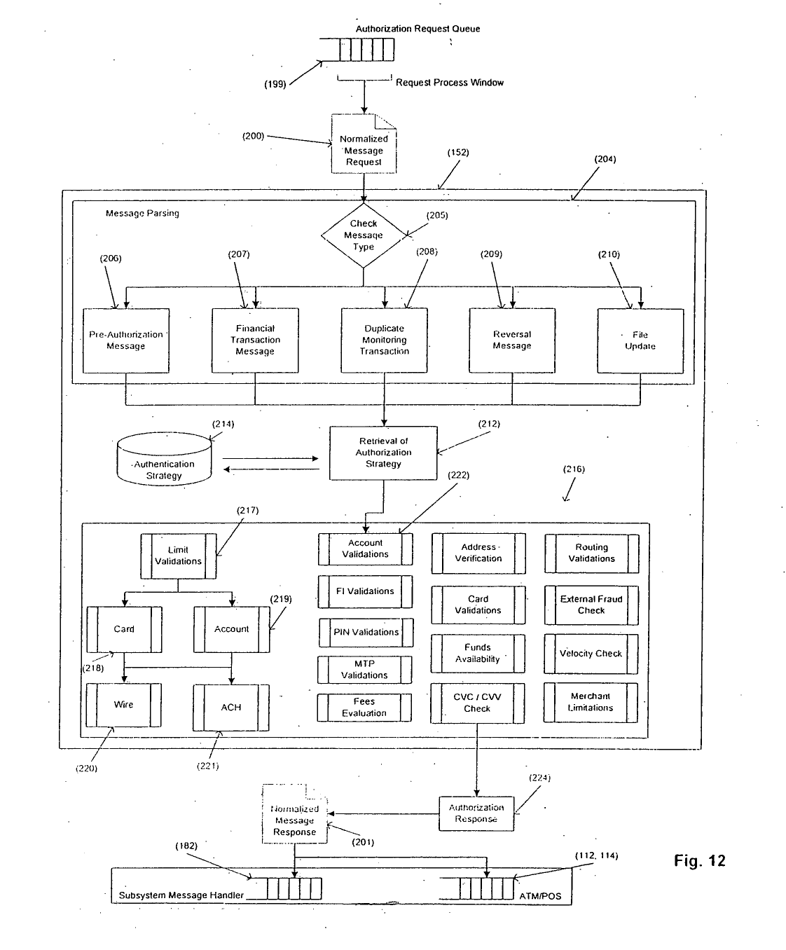

As shown in FIG. 12, once an authorization request is queued up as indicated at 199, the normalized authorization request message 200 is generated and transmitted to a message parsing system 204 which is part of the authorization processing system 153. The message parsing routine checks the message type at 205, and based on the message type generates the appropriate pre-authorization message 206, financial transaction message 207, or when required a reversal or decline message 209. The system also monitors for duplicate transactions as indicated at 208 and updates the system files for the user as indicated at 210. Once the specific transaction is identified and approved, the authorization strategy 214 is requested by and sent to the authorization retrieval subsystem 212. This then initiates and manages the authorization tasks as indicated at 216, including user specific and controlled information such as the card identification 218, limit validations 217 and the specific account to be used 219. This in turn initiates the transaction via wire 220 or other system such as ACH/SWITCH 221. The system also validates and checks other information as indicated at 222, including but not limited to account validations, address verification, routing validations, financial institution (FI) validations, card validations, external fraud check, PIN validations, funds availability, velocity check, money transfer partner (MTP) validations, card verification code/card verification value (CVC/CVV) check and merchant limitations. An authorization response is then generated at 224 and transmitted as a normalized message 201 back to the terminals 112, 114 and the subsystem message handler 182.

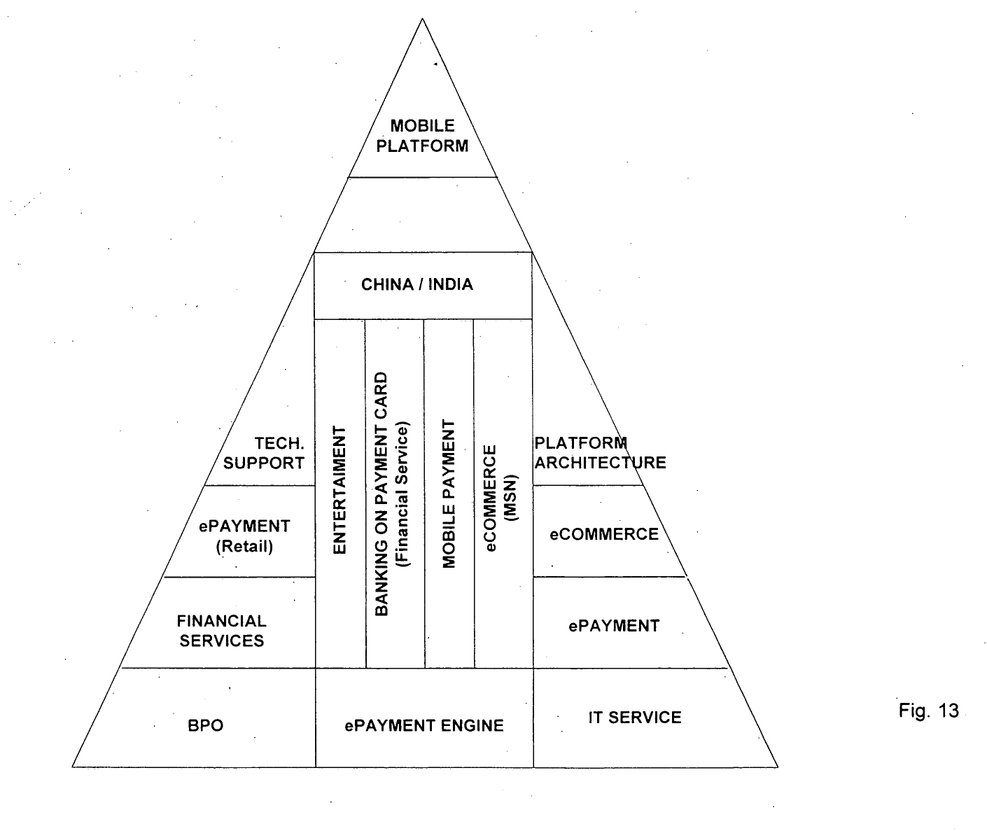

An overview of the applicability of the system is shown in FIG. 13. The preferred embodiment as described herein addresses the e-payment engine for supporting on line commerce transaction, entertainment transactions, financial services, merchant/consumer transaction as well as merchant procurement services. Mobile payments and e-commerce transactions are supported on both standard and mobile platforms. This can readily be expanded to support IT services such as e-payment, e-commerce and a platform arch, as well as BPO services for financial services, retail payment and technical support. In summary, the invention provides a comprehensive global payment system capable of supporting both North American-centric legacy systems such as ATM/POS systems and the ACH system as well as international systems not compatible with legacy systems. The system can handle both in single transactions without disruption.

While certain features and embodiments have been described in detail herein, it should be readily apparent the invention encompasses all modifications and enhancements within the scope and spirit of the following claims.

1. A global payment system for making real time payments by a first party to a second party via an electronic interface, the system comprising:
a. an input device for receiving first party data and a requested transaction;
b. a communication network for transmitting the first party data and the requested transaction to a payment system;
c. the payment system including a dedicated account defining a first party digital wallet for the first party from which funds may be transferred;
d. the payment system including a processor for verifying the first party information and the availability of funds in the digital wallet.

2. The global payment system of claim 1, further including a communications link with a bank for the digital wallet from existing accounts of the first party.

3. The global payment system of claim 1, wherein the digital wallet may be loaded by the first party physically transferring funds to the second party and the second party loading the digital wallet from his communication device.

4. The global payment system of claim 3, wherein the digital wallet of a consumer/user may be loaded by a merchant/agent anywhere on the system.

5. The global payment system of claim 3, wherein the digital wallet of a consumer/user may be loaded by a third party agency.

6. The global payment system of claim 3, wherein the digital wallet of a consumer/user may be loaded by a financial institution.

7. The global payment system of claim 1, further including a dedicated second party account, the payment system adapted for electronically transferring funds from the first party digital wallet to the dedicated second party account once the processor has verified the user information.

8. A global payment system for making real time payments by a user to a merchant via an electronic interface, the system comprising:
a. an input device for receiving user data and a requested transaction;
b. a communication network for transmitting the user data and the requested transaction to a payment system;
c. the payment system including a dedicated account defining a digital wallet for the user from which funds may be transferred;
d. the payment system including a processor for verifying the user information and the availability of funds in the digital wallet;
e. the payment system further including a dedicated merchant account;
e. the payment system adapted for electronically transferring funds from the user digital wallet to the dedicated merchant account once the processor has verified the user information.

9. The global payment system of claim 8, further including a communications link with a bank for the digital wallet from existing accounts of the user.

10. The global payment system of claim 8, wherein the digital wallet may be loaded by the user transferring funds to the merchant and the merchant requesting a transaction transferring merchant funds into the user digital wallet.

11. The global payment system of claim 8, wherein the merchant may initiate a transaction request to transfer funds from the merchant to the user digital wallet.

12. The global payment system of claim 8, further including a settlement system for accumulating and consolidating all transactions with a bank for bulk settling the multiple digital wallet and merchant accounts with the bank on a periodic basis.

13. The global payment system of claim 8, wherein the input device is a point-of-sale terminal.

14. The global payment system of claim 8, wherein the input device is an ATM terminal.

15. The global payment system of claim 8, wherein the input device is a cell phone.

16. The global payment system of claim 8, wherein the input device is PDA.

17. The global payment system of claim 8, wherein the input device is a computer terminal.

18. The payment system of claim 12, further including a payment transaction gateway and wherein the receiver processing system is adapted for communicating with the payment transaction gateway to receive authenticated user requests.

19. The payment system of claim 8, wherein the input device communicates with the receiver processing system via the Internet.

20. The payment system of claim 8, further including at least one financial institution adapted for communicating with the receiver processing system and wherein the requested transaction is completed through the financial institution in accordance with criteria set by the user and managed by the receiver processing system.

21. A method for making an electronic payment comprising the steps of:
a. establishing authenticating criteria for a user;
b. entering the user data for creating a user profile;
c. creating a digital wallet for the user containing account data and user privileges for containing available funds for a transaction;
d. initiating a transaction request at an input device;
e. communicating the user data and the transaction to a processing system;
f. validating the user and his privileges;
g. authenticating and authorizing the transaction;
h. completing the transaction in accordance with pre-established criteria and withdrawing funds from the user digital wallet.

22. The method of claim 21, wherein the user may identify and authorize a third party to use the digital wallet with pre-defined privileges.

23. The method of claim 21, wherein authenticating and authorizing step includes fraud management.

24. The method of claim 21, wherein the pre-established criteria includes establishing a hierarchy for selecting completion of the transaction from a plurality of user controlled accounts.

25. The method of claim 21, further including the following steps:
h. establishing a merchant account;
i. transferring funds withdrawn from the user digital wallet to the merchant account.

26. The method of claim 21, further including the step of transferring funds from the merchant account to the user account.
